(19) United States
(12) Patent Application Publication
(10) Pub. No.: US 2021/0188274 A1
(43) Pub. Date: Jun. 24, 2021

(54) METHOD OF CONTROLLING A VEHICLE AND DRIVER ASSIST SYSTEM

(71) Applicant: ZF FRIEDRICHSHAFEN AG, Friedrichshafen (DE)

(72) Inventors: CHRISTOPHER LEE GUIRLANDA, Brighton, MI (US); Mathew Austin Hudspeth, Warren, MI (US); Anthony Louis Rivas, Royal Oak, MI (US); Paul L. Mohan, Novi, MI (US)

(21) Appl. No.: 16/720,582

(22) Filed: Dec. 19, 2019

(51) Int. Cl. B60W 30/18; B60W 10/04; B60W 10/20; B60Q 9/00; B60W 10/18

(52) U.S. Cl. CPC B60W 30/18163; B60W 10/04; B60W 10/20; B60Q 9/00; B60W 2710/18; B60W 2550/12; B60W 2550/14; B60W 2720/106; B60W 2710/20; B60W 10/18

(57) ABSTRACT

A method of controlling a vehicle includes sensing forward road conditions of a road surface of the road forwardly adjacent to the vehicle in a direction of vehicle travel. Responsive to the sensed road conditions, a forward road signal is generated. Adjacent-lane road conditions of an adjacent-lane road surface of the road lateral to the forward road surface are sensed. Responsive to the sensed adjacent-lane road conditions, an adjacent-lane road signal is generated. The forward road signal and the adjacent-lane road signal are received, and a recommended amelioration action is responsively determined. The recommended amelioration action is communicated to an operator of the vehicle, and/or an adjustment of at least one of a speed of the vehicle and a lateral position on the road of the vehicle is initiated, responsive to the recommended amelioration action. A system of controlling a vehicle is also provided.

### TECHNICAL FIELD

This disclosure relates to a method of controlling a vehicle and a driver assist system and, more particularly, to a method and apparatus for affecting a vehicle to ameliorate potentially negative effects generated by ambient weather conditions.

### BACKGROUND

Vehicle driver assist systems that use a camera to monitor the environment surrounding the vehicle are known. A driver assist system can aid a driver in the operation of a motor vehicle by providing operational information such as a potential collision, lane or roadway departure, location of pedestrians, road sign information, etc. Data from the driver assist system is provided to other vehicle systems to provide the driver with a warning, haptic or tactile feedback, and/or autonomous control of the vehicle.

A driver assist system in a vehicle may include a camera or other sensor, using visible or non-visible wavelength “light” sources, that acquires information and provides the acquired information to a vehicle safety system designed to assist the driver. The camera or other sensor may be mounted in any desired location in the vehicle, such as the vehicle bumper or other frontward area to ensure a desired field of view.

### SUMMARY

In an aspect, a method of controlling a vehicle is provided. The method includes sensing forward road conditions of a forward road surface of the road forwardly adjacent to the vehicle in a direction of vehicle travel. Responsive to the sensed road conditions, a forward road signal is generated. Adjacent-lane road conditions of an adjacent-lane road surface of the road lateral to the forward road surface and in the direction of vehicle travel are sensed. Responsive to the sensed adjacent-lane road conditions, an adjacent-lane road signal is generated. The forward road signal and the adjacent-lane road signal are received, and a recommended amelioration action is responsively determined. The recommended amelioration action is communicated to an operator of the vehicle, and/or an adjustment of at least one of a speed of the vehicle and a lateral position on the road of the vehicle is initiated responsive to the recommended amelioration action.

In an aspect, a driver assist system is provided. A forward road sensor is operative to sense forward road conditions of a forward road surface of the road forwardly adjacent to the vehicle in a direction of vehicle travel and responsively generate a forward road signal. An adjacent-lane sensor is operative to sense adjacent-lane road conditions of an adjacent-lane road surface of the road lateral to the forward road surface and in the direction of vehicle travel and responsively generate an adjacent-lane road signal. A controller is operative to receive the forward road signal and the adjacent-lane road signal and responsively determine a recommended amelioration action. At least one of an operator communication device for communicating the recommended amelioration action to an operator of the vehicle, and a vehicle control system for adjusting at least one of a speed of the vehicle and a lateral position on the road of the vehicle responsive to the recommended amelioration action, is provided.

### BRIEF DESCRIPTION OF THE DRAWINGS

For a better understanding, reference may be made to the accompanying drawings, in which:

FIG. 1 is a schematic view of a vehicle in an ambient environment in adverse ambient atmospheric conditions;

FIG. 2 is a schematic view of a driver assist system according to an example aspect of the present invention;

FIGS. 3A-3C schematically depict a sequence of operation of a vehicle equipped with a driver assist system according to example aspects of the present invention;

FIG. 4 is a flowchart of an example sequence of operation of a driver assist system; and

FIG. 5 is a flowchart of another example sequence of operation of a driver assist system.

### DESCRIPTION OF ASPECTS OF THE DISCLOSURE

Unless defined otherwise, all technical and scientific terms used herein have the same meaning as is commonly understood by one of skill in the art to which the present disclosure pertains.

As used herein, the singular forms “a,” “an” and “the” can include the plural forms as well, unless the context clearly indicates otherwise. It will be further understood that the terms “comprises” and/or “comprising,” as used herein, can specify the presence of stated features, steps, operations, elements, and/or components, but do not preclude the presence or addition of one or more other features, steps, operations, elements, components, and/or groups thereof.

As used herein, the term “and/or” can include any and all combinations of one or more of the associated listed items.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms can encompass different orientations of a device in use or operation, in addition to the orientation depicted in the figures. For example, if a device in the figures is inverted, elements described as “under” or “beneath” other elements or features would then be oriented “over” the other elements or features.

As used herein, the phrase “at least one of X and Y” can be interpreted to include X, Y, or a combination of X and Y. For example, if an element is described as having at least one of X and Y, the element may, at a particular time, include X, Y, or a combination of X and Y, the selection of which could vary from time to time. In contrast, the phrase “at least one of X” can be interpreted to include one or more Xs.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present disclosure. The sequence of operations (or steps) is not limited to the order presented in the claims or figures unless specifically indicated otherwise.

The invention comprises, consists of, or consists essentially of the following features, in any combination.

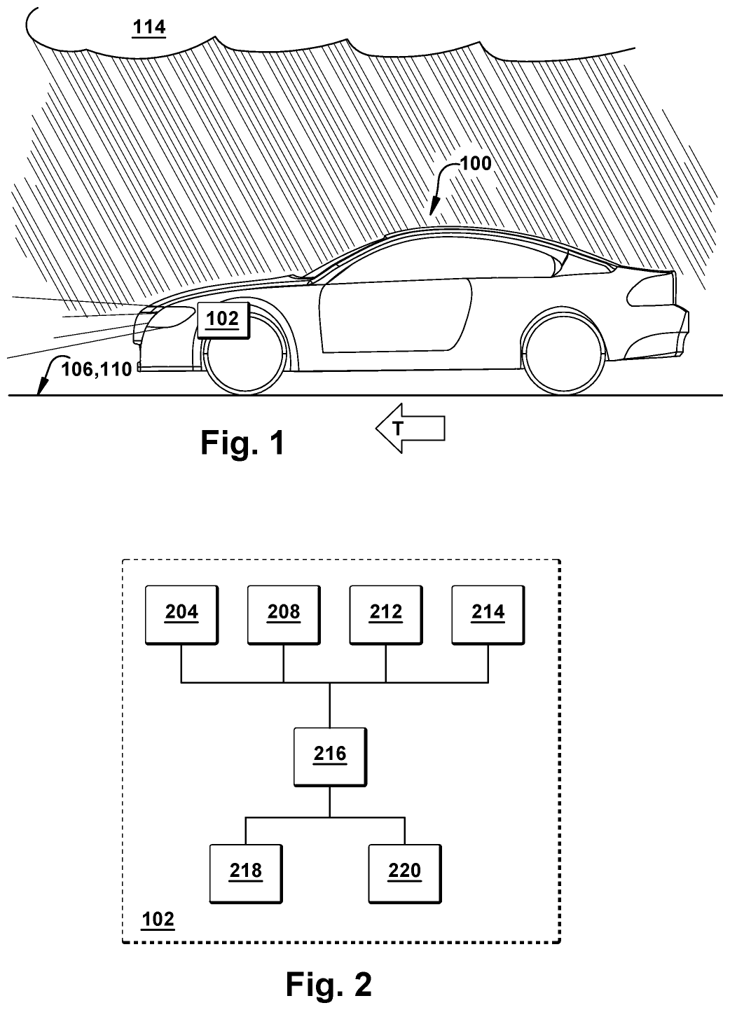

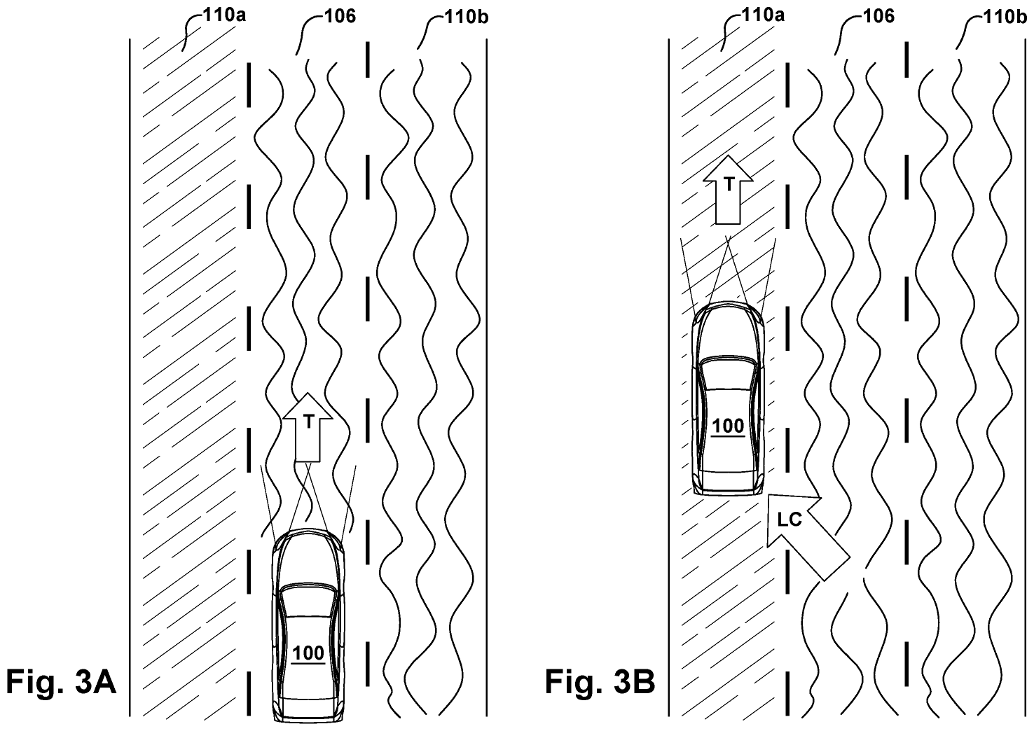

FIG. 1 depicts a vehicle 100 including a driver assist system 102. The driver assist system 102, shown in more detail in FIG. 2, includes a forward road sensor 204 operative to sense forward road conditions of a forward road surface 106 of the road forwardly adjacent to the vehicle 100 in a direction of vehicle travel and responsively generate a forward road signal. The direction of vehicle travel is shown schematically by arrow T in the Figures. An adjacent-lane sensor 208 is operative to sense adjacent-lane road conditions of an adjacent-lane road surface 110 of the road lateral to the forward road surface and in the direction of vehicle travel T and responsively generate an adjacent-lane road signal. The term “lateral” is used herein to indicate a direction substantially to the side of the direction of vehicle 100 travel.

It is contemplated that the forward road sensor 204 could perform the function of an adjacent-lane sensor (instead of or in addition to a standalone adjacent-lane sensor 208), such as by the forward road sensor 204 being provided with a sufficiently large field of view to encompass at least a portion of an adjacent-lane road surface 110. It is also contemplated that processing of signals from any of the sensors shown and described herein could be accomplished with reference to historical sensor data (e.g., regarding a road surface recently traversed), or with reference to available information of ambient weather, usual road conditions, or any other desired factor.

The present description presumes that the driver assist system 102 is being used in a divided highway-type road situation in which a plurality of lanes traveling in the same direction are available for the driver to select (i.e., the adjacent-lane is not occupied by oncoming traffic and/or a turn lane). However, it is presumed that the driver assist system 102 could be readily configured for use as desired in any of a number of road situations. For example, the driver assist system 102 could be used to detect a “clear track” created by the tires of previous vehicles in an otherwise-snowy lane and steer the vehicle 100 toward following the existing clear track, rather than selecting an entirely different lane. In the below description and attached claims, such “clear track” observations and shifts within a single lane should also be considered to be covered by descriptions referencing “changing lanes”, detecting conditions in “adjacent lanes”, or the like.

The driver assist system 102 of FIGS. 1 and 2 may include an ambient sensor 212 for sensing at least one ambient weather condition and responsively generating an ambient weather signal. For example, and as shown in FIG. 1, an ambient weather condition is shown schematically at 114 as including precipitation which can affect road surface conditions. The driver assist system 102 may be used, for example, when rainy, sleety, icy, snowy, and/or other conditions are present which might cause a driver to change her driving behavior to avoid undesirable handling of the vehicle 100.

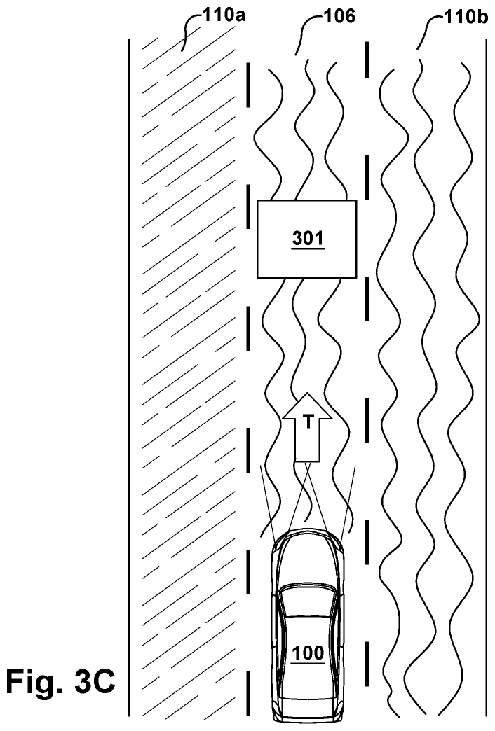

The adjacent-lane road surface 110 may be a first adjacent-lane road surface 110a located in a first lateral direction relative to the forward road surface. A second adjacent-lane road surface 110b of the road may be located lateral to the forward road surface 106. That is, the second adjacent-lane road surface 110b may be located in a second lateral direction, opposite the first lateral direction, to the forward road surface and in the direction of vehicle travel T. The situation is shown, for example, in FIGS. 3A and 3B as including a three-lane highway in the direction of vehicle travel T and will be described in more detail below. The driver assist system 102 is configured for sensing at least one of a presence, an area of road surface coverage, and a depth of road surface coverage of at least one of ice, snow, and water upon the forward road surface, the first adjacent-lane road surface 110a, and/or the second adjacent-lane road surface 110b.

When a second adjacent-lane road surface 110b is present, the driver assist system 102 may include a second adjacent-lane sensor 214 operative to sense second adjacent-lane road conditions of a second adjacent-lane road surface 110b of the road lateral to the forward road surface, located in a second lateral direction, opposite the first lateral direction, to the forward road surface and in the direction of vehicle travel T. When present, the second adjacent-lane sensor 214 is operative to responsively generate a second adjacent-lane road signal.

The driver assist system 102 includes a controller 216 which is operative to receive the forward road signal, the ambient weather signal, and/or the first and second adjacent-lane road signals, as appropriate and present in that use environment, and responsively determine a recommended amelioration action. The recommended amelioration action may be, for example, at least one of reducing a motive power output of an engine of the vehicle 100, actuating a braking system of the vehicle 100, steering the vehicle 100 laterally within a lane of the road in which the vehicle is already traveling, steering the vehicle 100 laterally into an adjacent-lane of the road, and alerting the driver of some recommended response (e.g., manually braking, slowing, and/or changing lanes).

It is contemplated, for example, that the controller 216 could include a lookup table or other “reference resource” to adjust braking, steering, and/or throttle control within predefined parameters. For example, steering could be restricted to a predefined range of angles from the current travel direction, depending on the type and amount of moisture or other substance present on the forward road surface 106. Similarly, a braking lookup table could adjust automatic braking force responsive to road conditions and/or a calculated or sensed coefficient of friction between the vehicle 100 and the road surface.

The controller 216 may look to the ambient weather signal to assist with the determination of the recommended amelioration action. (E.g.: is it raining, or did the vehicle 100 just drive through an area of standing water? Or, is the temperature low enough that the moisture on the forward road surface 106 could be ice? Is hydroplaning occurring or likely?) The driver assist system 102 could also or instead provide a hierarchy of recommended amelioration actions, ranked based on some other factor(s) such as, for example, a travel speed of the vehicle 100. Braking, steering, and other driving systems could be adjusted to take into account potentially-slippery conditions and thus, for example, provide alerts to the driver using more conservative logic or algorithms.

The controller 216 may communicate with one or more of the forward road sensor 204, adjacent-lane sensor 208, second adjacent-lane sensor 214, and/or ambient sensor 212 in any desired wired and/or wireless manner to receive the corresponding signals from these sensors and/or provide instructions, responses, or any other communications to whichever of these sensors are present in the driver assist system 102. The driver assist system 102 may be installed on the vehicle 100 during manufacture and/or provided as an aftermarket option. The driver assist system 102, or components thereof, may be located in any desired position inside and/or outside the vehicle. It is contemplated (when present) that, for example, the forward road sensor 204, adjacent-lane sensor 208, and/or second adjacent-lane sensor 214 may be provided as part of a headlight assembly, such as that shown and described in copending U.S. patent application filed Dec. 19, 2019 and entitled APPARATUS AND METHOD FOR ASCERTAINING INFORMATION VIA REFLECTION OF BOTH VISIBLE AND INVISIBLE WAVELENGTH LIGHT FROM A SURFACE (attorney docket no. DAS-029088 US PRI), the entire contents of which are incorporated herein by reference.

Through use of the driver assist system 102, road conditions ahead of the vehicle 100 can be detected and analyzed, particularly during adverse ambient weather conditions. For example, the driver assist system 102 can detect whether the forward road surface 106 in the lane immediately ahead is icy or wet and alert the driver and/or cause the vehicle 100 to take some action in response to this determination. Stated differently, the controller 216 receives the forward road signal, the ambient weather signal, and/or the first and second adjacent-lane road signals, determines whether the road conditions are potentially adverse, and passes that information along for action by another portion of the vehicle 100. The controller 216 could also or instead use information such as, but not limited to, a travel speed of the vehicle, an ambient light level, the presence or absence of one or more other vehicles around the vehicle 100, or any other suitable information when determining the recommended amelioration action.

More specifically, the driver assist system 102 can include at least one of an operator communication device 218 for communicating the recommended amelioration action to an operator of the vehicle 100, and a vehicle control system 220 for adjusting at least one of a speed of the vehicle 100 and a lateral position on the road of the vehicle 100 responsive to the recommended amelioration action. That is, the controller 216 can provide information on the recommended amelioration action to the driver for action and/or to an autonomous vehicle system of any suitable type.

When the recommended amelioration action is provided to the driver, the operator communication device 218 may be at least one of a visual, audible, haptic, and tactile user-perceptible indicator corresponding to the recommended amelioration action. For example, the steering wheel could vibrate to indicate to the driver that she should reduce the throttle without braking. As another example, a light could flash to direct the driver to apply the brake, with a fast flash for hard braking and a slow flash for more gradual braking. As yet another example, a tone on one channel of a stereo audible indicator could prompt the driver to change to a right or left lane, depending on which channel carries the tone. A “caution light” on the dashboard could illuminate to let the driver know that the road may be slippery but no immediate action is needed, as one more example. One of ordinary skill in the art can provide a suitable operator communication device 218 for effectively informing the driver of the recommended amelioration action.

When the controller 216 also or instead provides information on the recommended amelioration action to a vehicle control system 220, the vehicle control system 220 could take any of the recommended amelioration actions, potentially, though not necessarily, with no confirmatory input provided by the driver. That is, the vehicle control system 220 could release the throttle, apply the brakes, or even steer the vehicle 100 to change lanes (assuming an adjacent lane is available to the vehicle control system 220 to use, such as being free of another vehicle) in response to the recommended amelioration action. As a result, the driver assist system 102 can affect a vehicle 100 to ameliorate potentially negative effects generated by ambient weather conditions.

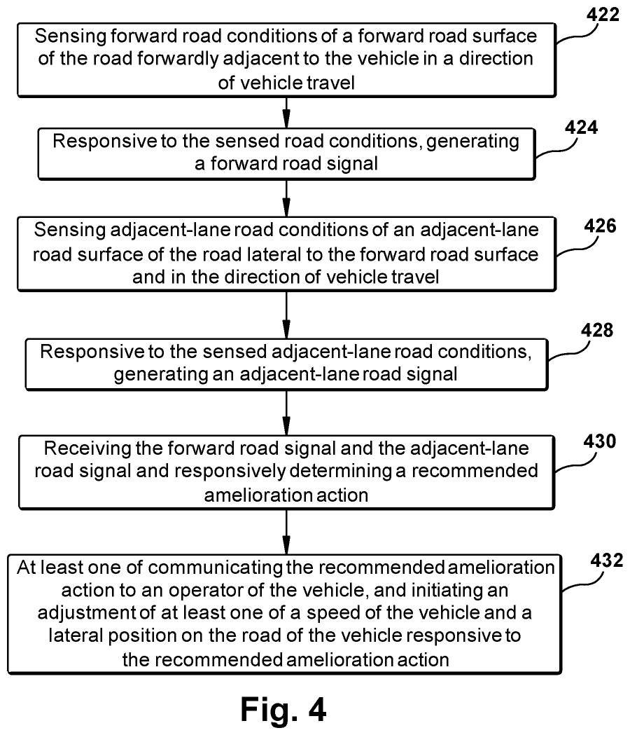

FIGS. 3A-3B schematically depict a pictorial sequence of action of a vehicle 100 traveling in adverse ambient weather conditions. This example sequence is depicted schematically via the flowchart of FIG. 4, which will now be described.

The method begins in first action block 422, wherein forward road conditions of the forward road surface 106 of the road forwardly adjacent to the vehicle 100 in a direction of vehicle travel T are sensed. Moving to second action block 424, a forward road signal is generated responsive to sensed road conditions. Concurrently or sequentially, in the third action block 426, adjacent-lane road conditions of an adjacent-lane road surface are sensed. Then, in fourth action block 428, an adjacent-lane road signal is generated responsive to the sensed adjacent-lane road condition. The sensing and signal generation of first through fourth action blocks 422-428 may be performed as often as desired, and in any desired sequence.

Proceeding now to fifth action block 430, the forward road signal in the adjacent-lane road signal are received (e.g., by the controller 216), and a recommended amelioration action is determined responsive to the received signals, which could also or instead include signals from an ambient sensor 212 and/or a second adjacent-lane sensor 214. It is also contemplated, for example, that when an ambient sensor 212 indicates favorable weather conditions, the sensing and signal generation of first through fifth action blocks 422-430 may selectively be paused, or a later step in the method could be omitted, so as not to distract the driver or for any other reason.

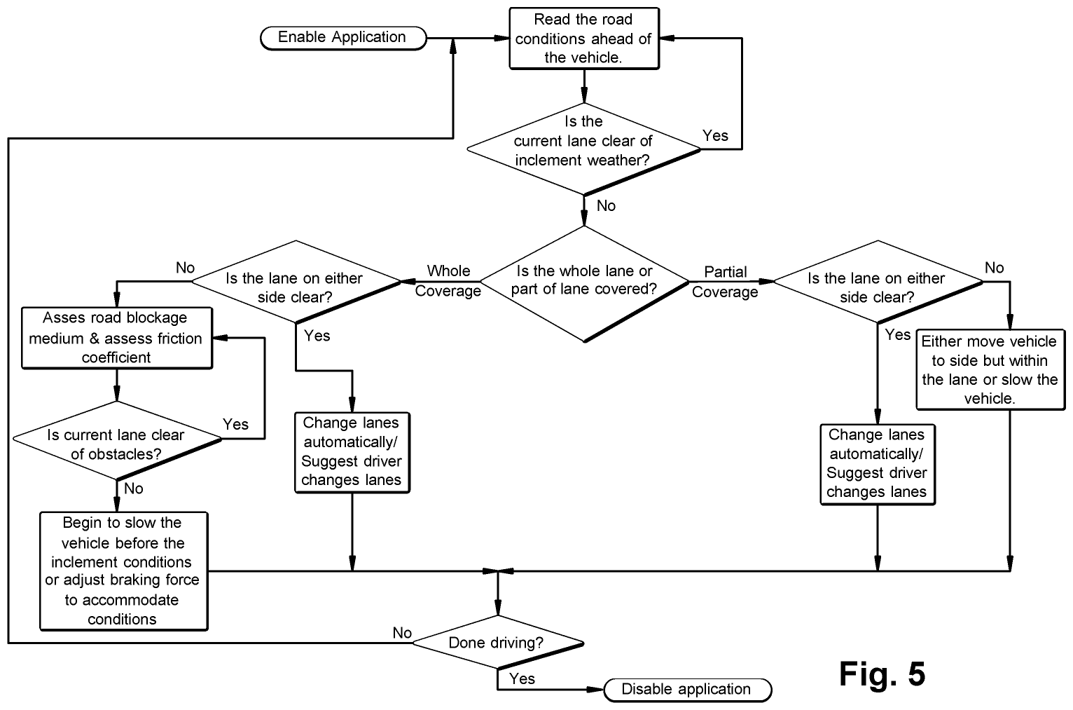

With reference to FIG. 3A, the actions of the flowchart of FIGS. 4-5 are being performed as the vehicle 100 is moving in travel direction T along the forward road surface 106. As shown in this Figure, the forward road surface 106 and a second adjacent-lane road surface 110b are at least partially covered by water, ice, snow, or another artifact of unfavorable ambient weather. However, also as shown in FIG. 3A, the first adjacent-lane road surface 110a has less, or no, such undesirable covering. This situation could occur, for example, if the first adjacent-lane road surface has better drainage or has been recently traversed by a snowplow. The recommended amelioration action in the driving situations schematically depicted in FIG. 3A therefore, could be for the vehicle 100 to change lanes, into the first adjacent-lane. Another, either concurrent or sequential amelioration action, could be for the vehicle 100 to apply the brakes to reduce speed, before, during, or after changing into the first adjacent-lane.

The driver assist system 102 is equipped to detect this differential surface condition between the forward road surface 106 and the first adjacent-lane road surface 110a and responsibly communicate to the operator and/or to a vehicle control system 220 that the first adjacent-lane road surface 110a could have more favorable surface conditions for driving. Stated differently, and as shown in sixth action block 432, the recommended amelioration action is communicated to an operator of the vehicle, and/or a vehicle control system 220 or other fully or partly autonomous system is directed to initiate an adjustment of at least one of a speed of the vehicle and a lateral position on the road of the vehicle responsive to the recommended amelioration action.

In the case of the driving conditions shown in FIG. 3A-3B, the recommended amelioration action is to change lanes laterally, into the first adjacent-lane, as well as to apply the brakes of the vehicle 100. This is shown pictorially in FIG. 3B, with the vehicle 100 moving laterally in lane change direction LC during its forward travel, as well as by the actuation of the brakes. The vehicle can then continue travel in direction of vehicle travel T, in what was formerly the first adjacent-lane and then, after the lane change, becomes the lane of current forward travel, for future calculations by the driver assist system 102. One of ordinary skill in the art will be able to determine and track which lane the vehicle is traveling in, for the purposes of use of the driver assist system 102 or of any other autonomous and/or partially assisted driving systems, or operator communication devices 218, as operation of the vehicle continues.

FIG. 3C depicts a situation in which an obstacle 301 (e.g., another vehicle, a cyclist, a pedestrian, road debris, or any other irregularity in the road ahead) is located in the lane of current vehicle travel T. It is contemplated that the forward road sensor 204, adjacent lane sensor 208, another sensor (not shown), or any other component of the vehicle 100 could provide information to the controller 216 regarding the presence and/or physical characteristics of any obstacle 301 in the forward and/or adjacent lanes of travel. The controller 216 could then take that information into account when considering potential amelioration action recommendations.

It is contemplated that one or more sensors of the vehicle 100 could include two or more ranging modes, as appropriate, (e.g., “high beam” and “low beam”) to gather information about road surface conditions and/or obstacles at varying distances from the vehicle 100 (to the front, rear, laterally, and/or any desired combinations thereof). The ranging mode for each sensor could be selected by the controller 216 responsive to factors including, but not limited to, ambient weather conditions and vehicle speed. Information could also or instead be provided to the controller 216 from a source external to the vehicle such as, but not limited to, an adjacent vehicle, a “smart” road sign or traffic broadcast, or any other source.

Finally, FIG. 5 is a flowchart giving an example decision tree for use of the driver assist system 102 with the vehicle. The decisions and actions shown in FIG. 5 could be carried out, singly or in any desired combination, by any suitable portion of the driver assist system 102 or any other systems of the vehicle 100.

While aspects of this disclosure have been particularly shown and described with reference to the example aspects above, it will be understood by those of ordinary skill in the art that various additional aspects may be contemplated. For example, the specific methods described above for using the apparatus are merely illustrative; one of ordinary skill in the art could readily determine any number of tools, sequences of steps, or other means/options for placing the above-described apparatus, or components thereof, into positions substantively similar to those shown and described herein. In an effort to maintain clarity in the Figures, certain ones of duplicative components shown have not been specifically numbered, but one of ordinary skill in the art will realize, based upon the components that were numbered, the element numbers which should be associated with the unnumbered components; no differentiation between similar components is intended or implied solely by the presence or absence of an element number in the Figures. The term “substantially” is used herein to indicate a quality that is largely, but not necessarily wholly, that which is specified—a “substantial” quality admits of the potential for some relatively minor inclusion of a non-quality item. Though certain components described herein are shown as having specific geometric shapes, all structures of this disclosure may have any suitable shapes, sizes, configurations, relative relationships, cross-sectional areas, or any other physical characteristics as desirable for a particular application. Any structures or features described with reference to one aspect or configuration could be provided, singly or in combination with other structures or features, to any other aspect or configuration, as it would be impractical to describe each of the aspects and configurations discussed herein as having all of the options discussed with respect to all of the other aspects and configurations. A device or method incorporating any of these features should be understood to fall under the scope of this disclosure as determined based upon the claims below and any equivalents thereof.

Other aspects, objects, and advantages can be obtained from a study of the drawings, the disclosure, and the appended claims.

We claim:

1. A method of controlling a vehicle, the method comprising:
sensing forward road conditions of a forward road surface of the road forwardly adjacent to the vehicle in a direction of vehicle travel;
responsive to the sensed road conditions, generating a forward road signal;
sensing adjacent-lane road conditions of an adjacent-lane road surface of the road lateral to the forward road surface and in the direction of vehicle travel;
responsive to the sensed adjacent-lane road conditions, generating an adjacent-lane road signal;
receiving the forward road signal and the adjacent-lane road signal and responsively determining a recommended amelioration action; and
at least one of communicating the recommended amelioration action to an operator of the vehicle, and initiating an adjustment of at least one of a speed of the vehicle and a lateral position on the road of the vehicle responsive to the recommended amelioration action.

2. The method of claim 1, including:
sensing at least one ambient weather condition;
responsive to the sensed at least one ambient weather condition, generating an ambient weather signal; and
wherein receiving the forward road signal and the adjacent-lane road signal and responsively determining a recommended amelioration action includes receiving the ambient weather signal and responsively determining, in conjunction with the forward road signal and the adjacent-lane road signal, the recommended amelioration action.

3. The method of claim 1, wherein the recommended amelioration action is at least one of reducing a motive power output of an engine of the vehicle, actuating a braking system of the vehicle, steering the vehicle laterally within a lane of the road in which the vehicle is already traveling, and steering the vehicle laterally into an adjacent-lane of the road.

4. The method of claim 1, wherein communicating the recommended amelioration action to an operator of the vehicle includes operating at least one of a visual, audible, haptic, and tactile indicator corresponding to the recommended amelioration action.

5. The method of claim 1, wherein sensing forward road conditions of a forward road surface of the road forwardly adjacent to the vehicle in a direction of vehicle travel includes sensing at least one of a presence, an area of road surface coverage, and a depth of road surface coverage of at least one of ice, snow, and water upon the forward road surface.

6. The method of claim 1, wherein sensing adjacent-lane road conditions of an adjacent-lane road surface of the road lateral to the forward road surface and in the direction of vehicle travel includes sensing at least one of a presence, an area of road surface coverage, and a depth of road surface coverage of at least one of ice, snow, and water upon the adjacent-lane road surface.

7. The method of claim 1, wherein the adjacent-lane road surface is a first adjacent-lane road surface located in a first lateral direction relative to the forward road surface, the method including:
sensing second adjacent-lane road conditions of a second adjacent-lane road surface of the road lateral to the forward road surface, located in a second lateral direction, opposite the first lateral direction, to the forward road surface and in the direction of vehicle travel;
responsive to the sensed second adjacent-lane road conditions, generating a second adjacent-lane road signal; and
receiving the forward road signal and the first and second adjacent-lane road signals and responsively determining a recommended amelioration action.

8. A driver assist system, the system comprising:
a forward road sensor operative to sense forward road conditions of a forward road surface of the road forwardly adjacent to the vehicle in a direction of vehicle travel and responsively generate a forward road signal;
an adjacent-lane sensor operative to sense adjacent-lane road conditions of an adjacent-lane road surface of the road lateral to the forward road surface and in the direction of vehicle travel and responsively generate an adjacent-lane road signal;
a controller operative to receive the forward road signal and the adjacent-lane road signal and responsively determine a recommended amelioration action; and
at least one of an operator communication device for communicating the recommended amelioration action to an operator of the vehicle, and a vehicle control system for adjusting at least one of a speed of the vehicle and a lateral position on the road of the vehicle responsive to the recommended amelioration action.

9. The driver assist system of claim 8, including an ambient sensor for sensing at least one ambient weather condition and responsively generating an ambient weather signal; and
wherein the controller is operative to receive the ambient weather signal, the forward road signal, and the adjacent-lane road signal and responsively determine a recommended amelioration action.

10. The driver assist system of claim 8, wherein the recommended amelioration action is at least one of reducing a motive power output of an engine of the vehicle, actuating a braking system of the vehicle, steering the vehicle laterally within a lane of the road in which the vehicle is already traveling, and steering the vehicle laterally into an adjacent-lane of the road.

11. The driver assist system of claim 8, wherein the operator communication device is at least one of a visual, audible, haptic, and tactile user-perceptible indicator corresponding to the recommended amelioration action.

12. The driver assist system of claim 8, wherein the adjacent-lane road surface is a first adjacent-lane road surface located in a first lateral direction relative to the forward road surface, the apparatus including:
a second adjacent-lane sensor operative to sense second adjacent-lane road conditions of a second adjacent-lane road surface of the road lateral to the forward road surface, located in a second lateral direction, opposite the first lateral direction, to the forward road surface and in the direction of vehicle travel and responsively generate a second adjacent-lane road signal; and
wherein the controller is operative to receive the forward road signal and the first and second adjacent-lane road signals and responsively determine a recommended amelioration action.
